(19) United States
(12) Patent Application Publication
(10) Pub. No.: US 2017/0337482 A1
(43) Pub. Date: Nov. 23, 2017

(54) PREDICTIVE SYSTEM FOR INDUSTRIAL INTERNET OF THINGS

(71) Applicants: SURAJ SINDIA, HILLSBORO, OR (US); SHRUTI AGARWAL, HILLSBORO, OR (US); MUSTAFA BERKE YELTEN, ISTANBUL (TR); CHRISTOPHER L. TICE, WORCESTER, MA (US); TERESA KRYSTYNA JANCZAK, HILLSBORO, OR (US); SCOTT C. JOHNSON, PORTLAND, OR (US)

(72) Inventors: SURAJ SINDIA, HILLSBORO, OR (US); SHRUTI AGARWAL, HILLSBORO, OR (US); MUSTAFA BERKE YELTEN, ISTANBUL (TR); CHRISTOPHER L. TICE, WORCESTER, MA (US); TERESA KRYSTYNA JANCZAK, HILLSBORO, OR (US); SCOTT C. JOHNSON, PORTLAND, OR (US)

(21) Appl. No.: 15/160,429

(22) Filed: May 20, 2016

(51) Int. Cl. G06N 7/00; G06N 3/08

(52) U.S. Cl. CPC G06N 7/005; G06N 3/08

(57) ABSTRACT

Systems, apparatuses, and methods for enabling sensor discovery in autonomous devices herein. An example device to perform system-level verification predictions includes a neural network circuit including a neural network. During a first phase, the neural network circuit to train the neural network using respective assembly-level test data and the system-level verification test data associated with each of a first plurality of semiconductor dice. The first plurality of semiconductor dice is produced from a plurality of training wafers. During a second phase, the neural network circuit to determine, using the neural network, a system-level pass/fail decision for each of second plurality of semiconductor dice based on respective assembly-level test data associated with each of the second plurality of semiconductor dice. The second plurality of semiconductor dice is produced from a plurality of production wafers.

### BACKGROUND

Some manufacturing processes may include incremental assembly (e.g., fabrication, construction, etc.) and test processes to ensure that a product is meeting specifications throughout the assembly process, and allow for correction or removal of products that fail before reaching the end. Once a final product is assembled, final system-level verification testing may be conducted on the final product to ensure the final product meets intended specifications and operates as expected. However, system-level testing can be time consuming and expensive, which may result in increased production throughput and costs.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates components of an industrial Internet-of-Things predictive system in accordance with some embodiments.

FIG. 2 illustrates components of an industrial Internet-of-Things (IoT) predictive system in accordance with some embodiments.

FIG. 3 illustrates an industrial Internet-of-Things (IoT) predictive semiconductor die fabrication system (system) 300 according to an embodiment of the disclosure.

FIG. 4 illustrates a method to venerate system-level verification predictions in accordance with some embodiments.

FIG. 5 illustrates a method to generate system-level verification predictions in accordance with some embodiments.

FIG. 6 is a block diagram illustrating an example machine upon which any one or more of the techniques (e.g., methodologies) discussed herein may perform, according to an example embodiment.

### DETAILED DESCRIPTION

Certain details are set forth below to provide a sufficient understanding of embodiments of the disclosure. However, it will be clear to one skilled in the art that embodiments of the disclosure may be practiced without various aspects of these particular details. In some instances, well-known circuits, control signals, timing protocols, computer system components, and software operations have not been shown in detail in order to avoid unnecessarily obscuring the described embodiments of the disclosure.

Examples of an industrial Internet-of-Things (IoT) predictive verification systems described herein may allow for predictive verification of end products using a predictive engine. The predictive engine may be trained to predict which end products are likely to pass system-level verification testing, and which. end products are likely to fail. Predictions from the predictive engine for individual end products may be used in place of system-level testing to determine pass/fail verification, which may reduce production costs and increase production throughput.

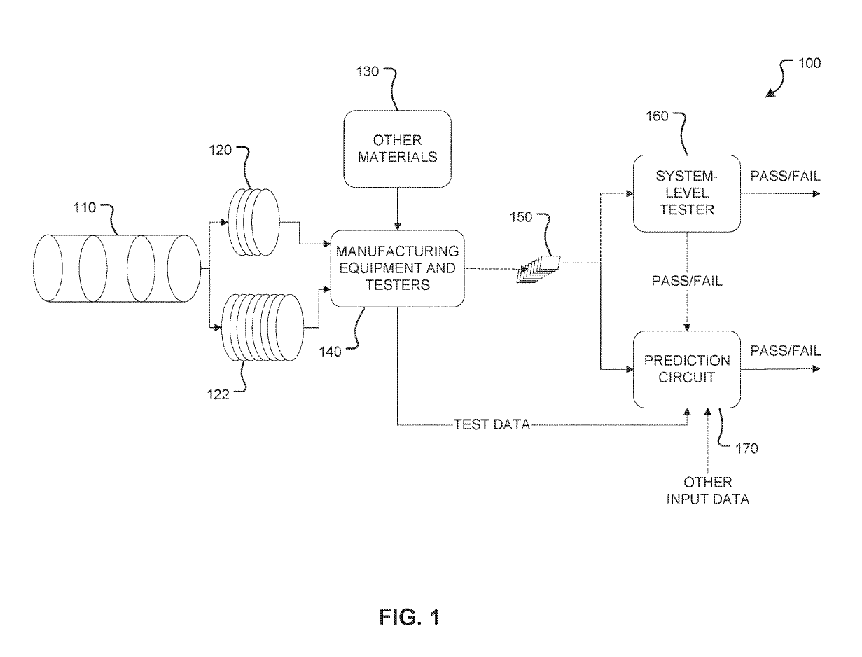

FIG. 1 illustrates an industrial Internet-of-Things (IoT) predictive system (system) 100 according to an embodiment of the disclosure. The system 100 may pertain to drug development and manufacturing, automobile/aircraft assembly and manufacturing, consumer electronic systems assembly and manufacturing, or other manufacturing or industrial environments. The system 100 may include a prediction circuit 170 trained to predict whether end products will pass or fail system-level verification tests based on test data from a manufacturing process. The system 100 may include a supply 110 that is divided into several training units 120 and several production units 122. The training units 120 and the production units 122 may undergo assembly (e.g., fabrication, construction, etc.) and testing via manufacturing equipment and. testers 140 to provide respective end products 150. The respective end products 150 may be provided to one or both of a system-level tester 160 and the prediction circuit 170 to determine whether individual ones of the end products 150 pass or fail system-level verification testing.

The supply 110 may include any material, device, component, assembly, etc. used in a manufacturing process to produce the end products 150. The supply 110 may be divided into the training units 120 and the production units 122. The manufacturing equipment and testers 140 may include manufacturing (e.g., fabricating, assembly, sensing, construction, etc.) equipment used during the manufacturing process to provide a plurality of the end products 150. The manufacturing equipment and testers 140 may further include testers that incrementally test the training units 120 and the production units 122 at designated points in the manufacturing process as the training units 120 and the production units 122 transform into the end products 150. The manufacturing equipment and testers 140 may include transceivers that allow the manufacturing equipment and testers 140 to communicate with each other, the system-level tester 160, the prediction circuit 170, or combinations thereof. In some embodiments, the testers may be integrated with the manufacturing equipment of the manufacturing equipment and testers 140.

The system-level tester 160 may perform a system-level verification test on the end products 150 to determine whether one of the end products 150 meet design specifications. During a first phase, the prediction circuit 170 may be trained to predict whether each of the end products 150 will pass or fail the system-level verification test based on test data from the testers of the manufacturing equipment and testers 140 and test data from the system-level tester 160. During a second phase, the prediction circuit 170 may be used to make pass/fail determinations.

In operation, the supply 110 may be divided into the training units 120 and the production units 122. During a first phase (e.g., training phase), the training units 120 may be put through the manufacturing equipment and testers 140 and the resultant end products 150 may tested via system-level tester 160 to determine whether each individual end-product passes or fails a system-level verification test. Test data from the manufacturing equipment and testers 140 and the system-level tester 160 may be used to train the prediction circuit 170. During a second phase(e.g., test phase), the production units 122 may be may be put through the manufacturing equipment and testers 140 to provide the resultant end products 150 and resultant test data. The resultant test data for each of the end products 150 may be provided to the prediction circuit 170, and the prediction circuit 170 may use the resultant test data to determine whether each individual end-product of the end products 150 passes or fails a system-level verification test. Determining pass/fail information using the prediction circuit 170, rather than performing the system-level verification test may reduce manufacturing costs and time.

During assembly, each of the training units 120 and production units 122 may undergo assembly-level tests as they are transformed into the respective end products 150. During the first phase, the system-level tester 160 may perform system-level verification testing on each of the end products 150 from the training units 120 to determine pass or fail information. The test data from the manufacturing equipment and testers 140 and from the system-level tester 160 for the each of the end products 150 produced from the training units 120 may be provided to the prediction circuit 170. The prediction circuit 170 may use the test data from each of the manufacturing equipment and testers 140 and the system-level tester 160 to train a predictive model to be able to predict whether a given end products 150 is likely to pass or fail system-level verification testing.

Selection of the training units 120 for the first phase may be based on a location of each unit within the supply 110. For example, if the supply 110 is a solid block of material (e.g., ingot), the composition of the supply 110 may vary slightly from one point to another longitudinally within the supply 110. That is, longitudinally, the one end may have a slightly different composition than a middle portion, which may have a slightly different composition than a second end. Thus, the training units 120 may be selected to at various points along the longitudinal axis of the supply 110 in order to help improve robustness of training of the prediction circuit 170.

The manufacturing equipment and testers 140 may assemble and test the end products 150 from the training units 120 and the production units 122. The assembly may include multiple steps, and may include addition of other materials 130. The testers of the manufacturing equipment and testers 140 may test characteristics of the training units 120 and the production units 122 at certain assembly milestones as each of the training units 120 and the production units 122 transform into the end products 150. The manufacturing equipment and testers 140 may include transceivers to communicate the test data to the prediction circuit 170. In some examples, the manufacturing equipment and testers 140 may further communicate other telemetry data, such as enviromnental data or equipment health data, to the prediction circuit 170. The prediction circuit 170 may use the test data, telemetry data, or combinations thereof, during both the first and second phases. The manufacturing equipment and testers 140 may further communicate telemetry among each other or with a central computer during the assembly process. The communication of the telemetry data may be used to effect changes to the manufacturing equipment or the testers during assembly, such as a central computer or server changing one or more settings in the manufacturing equipment, the testers, the system-level tester 160, the prediction circuit 170, or combinations thereof In some examples, the prediction circuit 170 may be included in the central computer or server.

During the first phase, the system-level tester 160 may perform the system-level verification tests on the end products 150 produced from the training units 120 to make a pass/fail determination. The pass/fail determination from the system-level tester 160 may be provided to the prediction circuit 170. The prediction circuit 170 may use the test and/or other telemetry data from the manufacturing equipment and testers 140, along with the test data from the system-level tester 160, to train the predictive model. The training may include the prediction circuit 170 identifying correlations between the test and/or other telemetry data from the manufacturing equipment and testers 140 that result in pass indication from the system-level tester 160, and may identify correlations between test and other telemetry data from the manufacturing equipment and testers 140 that result in a fail indication from the system-level tester 160. In some embodiments, the predictive model of the prediction circuit 170 may include a neural network, such as a two-layer perceptron neural network.

Once the prediction circuit 170 is trained, the system 100 may enter a second phase in which the prediction circuit 170 makes system-level pass/fail determinations for individual ones of the end products 150 produced from the production units 122. In some examples, the prediction circuit 170 may directly provide the pass or fail for each of the end products 150 produced from the production units 122. In other examples, when the confidence of a predicted pass or fail by the prediction circuit 170 falls outside a threshold for a particular end products 150, the prediction circuit 170 may indicate performance of a system-level verification test is necessary by the system-level tester 160. Further, the predictive model of the prediction circuit 170 may be updated randomly (e.g., random selection of an additional pilot unit to undergo system-level verification testing), periodically (e.g., periodic selection of an additional pilot unit to undergo system-level verification testing), or as conditions within or around the manufacturing equipment and testers 140 change. In an embodiment, the system-level tester 160 may perform a system-level verification test on a select subset of end products 150 produced from each of the production units 122, and the test data from the manufacturing equipment and testers 140 and the system-level tester 160 for each of the subset of the end products 150 may be used to update the prediction circuit 170.

In some examples, the prediction circuit 170 may be stored as instructions in machine readable media of a computer or server that are executable by one or more processor units to train using data from the manufacturing equipment and testers 140 and the system-level tester 160 and to provide pass/fail predictions for the end products 150 using data from the manufacturing equipment and testers 140. In another example, the prediction circuit 170 may be included in the system-level tester 160. Using the predictive model of the prediction circuit 170 in lieu of performing system-level tests via the system-level tester 160 for the end products 150 may reduce production time and reduce production costs.

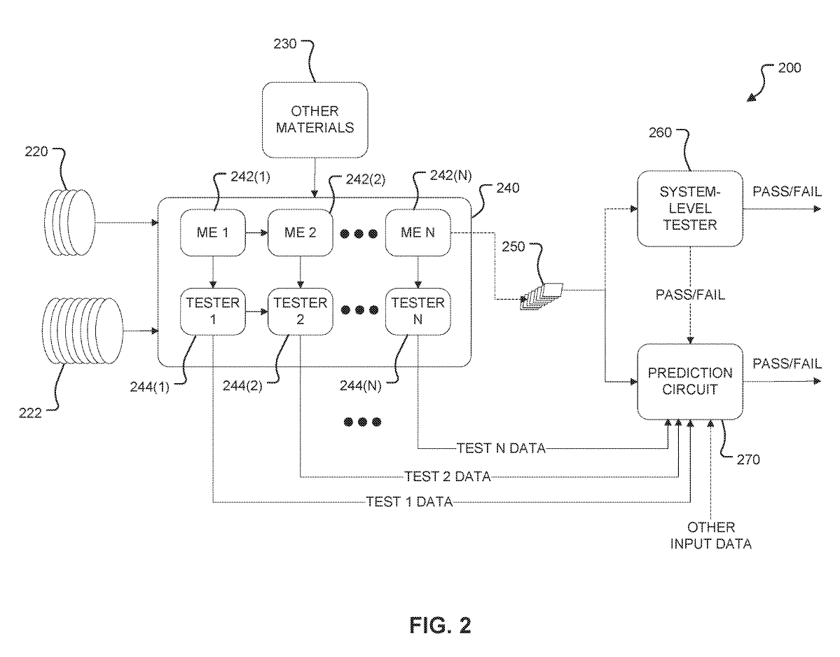

FIG. 2 illustrates an industrial Internet-of-Things (IoT) predictive system (system) 200 according to an embodiment of the disclosure. The system 200 may pertain to drug development and manufacturing, automobile,/aircraft assembly and manufacturing, consumer electronic systems assembly and manufacturing, or other manufacturing or industrial environments. The system 200 may include a prediction circuit 270 trained to predict whether end products will pass or fail system-level verification tests via a system-level tester 260 based on test data from a manufacturing process. The system 200 may include a supply (not shown) that is divided into several training units 220 and several production units 222. The training units 220 and the production units 222 may undergo assembly (e.g., fabrication, construction, etc.) and testing via manufacturing equipment and testers 240 to provide respective end products 250. The respective end products 250 may be provided to one or both of a system-level tester 260 and the prediction circuit 270 to determine whether individual ones of the end products 250 pass or fail system-level verification testing.

The supply may include any material, device, component, assembly, etc. used in a manufacturing process to produce the end products 250. The supply may be divided into the training units 220 and the production units 222. The manufacturing equipment and testers 240 may include manufacturing equipment 242(1-N) (e.g., fabricating, assembly, sensing, construction, etc., equipment) used during the manufacturing process to provide the end products 250. The manufacturing equipment and testers 240 may further include testers 244(1-N) that are coupled to respective ones of the manufacturing equipment 242(1-N) and perform respective tests on the training units 220 and the production units 222 after completion of an assembly step by the respective manufacturing equipment 242(1-N) as the manufacturing equipment and testers 240 transforms the training units 220 and the production units 222 into the end products 250. The manufacturing equipment 242(1-N) and testers 244(1-N) may include transceivers for communication with each other, the system-level tester 260, the prediction circuit 270, or combinations thereof. In some embodiments, the testers 244(1-N) may be integrated with the manufacturing equipment 242(1-N).

The system-level tester 260 may perform a system-level verification test on the end products 250 to determine whether one of the end products 250 meet design specifications. During a first phase, the prediction circuit 270 may be trained to predict whether each of the end products 250 will pass or fail the system-level verification test based on test data from the testers 244(1-N) of the manufacturing equipment and testers 240 and test data from the system-level tester 260 During a second phase, the prediction circuit 270 may be used to make pass/fail determinations.

In operation, the supply may be divided into the training units 220 and the production units 222. During a first phase (e.g., training phase), the training units 220 may be put through the manufacturing equipment and testers 240 and the resultant end products 250 may fully tested via system-level tester 260 to determine whether each individual end-product passes or fails a system-level verification test. Test data from the manufacturing equipment and testers 240 and the system-level tester 260 may be used to train the prediction circuit 270, During a second phase (e.g., test phase), the production units 222 may be may be put through the manufacturing equipment and testers 240 to provide the resultant end products 250 and resultant test data. The resultant test data for each of the end products 250 may be provided to the prediction circuit 270, and the prediction circuit 270 may use the resultant test data to determine whether each individual end-product of the end products 250 passes or fails a system-level verification test. Determining pass/fail information using the prediction circuit 270, rather than performing the system-level verification test may reduce manufacturing costs and time.

During assembly, each of the training units 220 and production units 222 may undergo assembly-level tests via the testers 244(1-N) as they are transformed into the respective end products 250. During the first phase, the system-level tester 260 may perform system-level verification testing on each of the end products 250 from the training units 220 to determine pass or fail information. The test data from the testers 244(1-N) and from the system-level tester 260 for the each of the end products 250 produced from the training units 220 may be provided to the prediction circuit 270. The prediction circuit 270 may use the test data from each of the manufacturing equipment and testers 240 and the system-level tester 260 to train the prediction circuit 270 to predict whether a given end products 250 is likely to pass or fail system-level verification testing.

Selection of the training units 220 for the first phase may be based on a location of each unit within the supply. For example, if the supply is a solid block of material (e.g., ingot), the composition of the supply may vary slightly from one point to another longitudinally within the ingot, That is, longitudinally, the one end may have a slightly different composition than a middle portion, which may have a slightly different composition than a second end. Thus, the training units 220 may be selected to at various points along the longitudinal axis of the supply in order to help improve robustness of training of the prediction circuit 270. 100271 The manufacturing equipment and testers 240 may assemble and test the end products 250 from the training units 220 and the production units 222. The assembly may include multiple steps performed by the manufacturing equipment 242(1-N), and may include addition of other materials 230. The manufacturing equipment 242(1-N) may each communicate with a respective tester 244(1-N). The testers 244(1-N) may perform assembly-level tests to measure characteristics of the training units 220 and the production units 222 at certain points in the assembly process as each of the training units 220 and the production units 222 transform into the end products 250. The manufacturing equipment 242(1-N) and the testers 244(1-N) may include transceivers to communicate the test data to the prediction circuit 270. In some examples, the manufacturing equipment and testers 240 may further communicate other telemetry data, such as environmental data or equipment health data, to the prediction circuit 270. The prediction circuit 270 may use the test data, telemetry data, or combinations thereof, during both the first and second phases. The manufacturing equipment 242(1-N) and testers 244(1-N) of the manufacturing equipment and testers 240 may further communicate telemetry with each other or with a central computer or server during the assembly process, The communication of the telemetry data may be used to effect changes to the manufacturing equipment 242(1-N) or the testers 244(1-N) during assembly, such as a central computer or server changing one or more settings in the manufacturing equipment 242(1-N), the testers 244(1-N), the system-level tester 260, the prediction circuit 270, or combinations thereof In some examples, the prediction circuit 270 may be included in the central computer or server.

During the first phase, the system-level tester 260 may perform the system-level verification tests on the end products 250 produced from the training units 220 to make a pass/fail determination. The pass/fail determination from the system-level tester 260 may be provided to the prediction circuit 270. The prediction circuit 270 may use the test and/or other telemetry data from the testers 244(1-N), along with the test data from the system-level tester 260, to train the predictive model. The training may include the prediction circuit 270 identifying correlations between the test and/or other telemetry data from the manufacturing equipment and testers 240 that result in pass indication from the system-level tester 260, and may identify correlations between test and other data from the manufacturing equipment and testers 240 that result in a fail indication from the system-level tester 260. One of skill in the art may preselect input parameters to be included in the test data provided to the prediction circuit 270 for training to quantify the dependence of these preselected input parameters to the output to be predicted. The parameters may be preselected based on prior knowledge of one of skill in the art of parameters that tend to correlate with system level performance metrics (e.g., system level pass/fail). In some embodiments, preselection of particular parameters may be unnecessary as the training of the neural network may provide for computation of individual input parameter weights, and thereby quantify the dependence of each of the individual input parameters to the output to be predicted (e.g., system level pass/fail.) In some embodiments, the predictive model of the prediction circuit 270 may include a neural network, such as a two-layer perceptron neural network.

Once the prediction circuit 270 is trained, the system 200 may enter a second phase in which the prediction circuit 270 makes system-level pass/fail determinations for individual ones of the end products 250 produced from the production units 222 based on test and other data from the testers 244(1-N). The prediction circuit 270 may be implemented determine pass or fail of individual ones of the end products 250 in lieu of performing comprehensive system-level verification tests via the system-level tester 260. In some examples, the prediction circuit 270 may directly provide the pass or fail for each. In other examples, when the confidence of a predicted pass or fail by the prediction circuit 270 falls outside a threshold for a particular end products 250, the prediction circuit 270 may indicate performance of a system-level verification test is necessary by the system-level tester 260. Further, the predictive model of the prediction circuit 270 may be updated randomly (e.g., random selection of an additional pilot unit to undergo system-level verification testing), periodically (e.g., periodic selection of an additional pilot unit to undergo system-level verification testing), or as conditions within or around the manufacturing equipment and testers 240 change. In an embodiment, the system-level tester 260 may perform a system-level verification test on a select subset of end products 250 produced from each of the production units 222, and the test data from the testers 244(1-N) and the system-level tester 260 for each of the subset of the end products 250 may be used to update the prediction circuit 170. Further, the prediction circuit 270 may be trained using another method, such as using historical test and pass/fail data, in some examples.

In some examples, the prediction circuit 270 may be stored as instructions at machine readable media of a computer or a server that are executable by one or more processor units to train using data from the manufacturing equipment and testers 240 and the system-level tester 260 and to provide pass/fail predictions for the end products 250 using data from the manufacturing equipment and testers 240, In another example, the prediction circuit 270 may be included in the system-level tester 260. Using the predictive model of the prediction circuit 270 in lieu of performing system-level tests via the system-level tester 260 for the end products 250 may reduce production time and. reduce production costs.

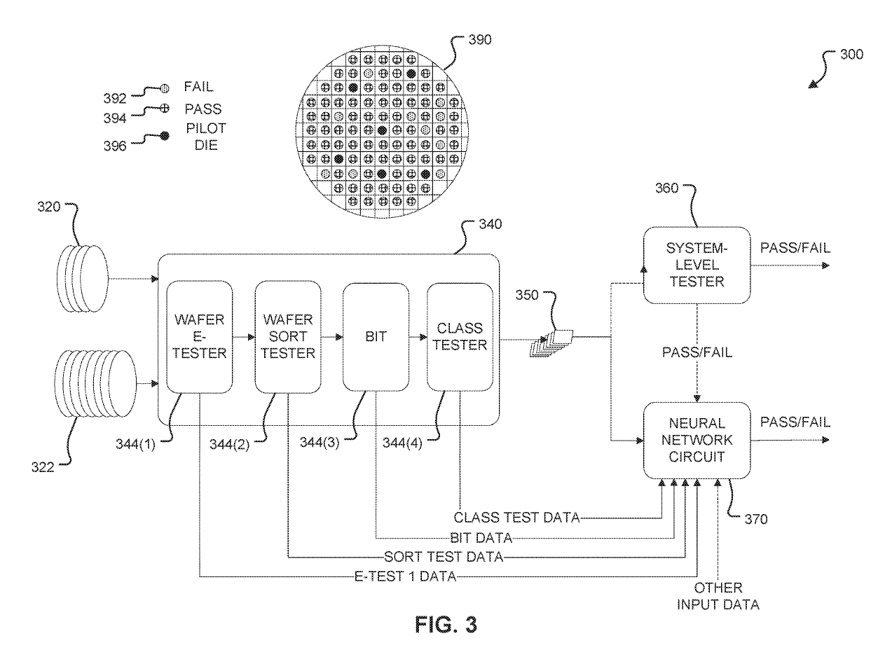

FIG. 3 illustrates an industrial Internet-of-Things (IoT) predictive semiconductor die fabrication system (system) 300 according to an embodiment of the disclosure. The system 300 may include a neural network circuit 370 trained to predict whether individual semiconductor dice 350 will pass or fail system-level verification tests via a system-level tester 360 based on test data from a manufacturing process. The system 300 may include an ingot that is divided into training wafers 320 and production wafers 322. Each of the training wafers 320 and the production wafers 322 may undergo and fabrication and assembly process that includes testing via manufacturing equipment and testers 340 to provide semiconductor dice 350. The semiconductor dice 350 may be provided to one or both of a system-level tester 360 and the neural network circuit 370 to determine whether individual ones of the semiconductor dice 350 pass or fail system-level verification testing.

The semiconductor material may include any material used in a manufacturing process to produce the semiconductor dice 350. The semiconductor material may sliced into wafers and divided into the training wafers 320 and the production wafers 322, The manufacturing equipment and testers 340 may include manufacturing equipment (not shown) and testers 344(1-4) that perform respective tests on the training wafers 320 and the production wafers 322 after completion of a fabrication or assembly step as the manufacturing equipment and testers 340 transforms the training wafers 320 into the semiconductor dice 350. The 344(1) may include a wafer-level test to measure wafer health along scribe lines of the wafer using special purpose inter-die variation (IDV) circuits. The 344(2) may perform a die-level test after fabrication, but before packaging to determine the health of each individual die. The 344(3) may perform a die-level built-in test using on-die logic to determine health of the individual die. The 344(4) may perform class tests on the dice after packaging to determine health of an individual die. The testers 344(1-4) may include transceivers for communication with each other, the system-level tester 360, the neural network circuit 370, or combinations thereof. In some embodiments, the testers 344(1-4) may be integrated with the manufacturing equipment of the manufacturing equipment and testers 340.

The system-level tester 360 may perform a system-level verification test on the semiconductor dice 350 to determine whether one of the semiconductor dice 350 meet design specifications. During a first phase, the prediction circuit 370 may be trained to predict whether each of the semiconductor dice 350 will pass or fail the system-level verification test based on test data from the testers 344(1-4) of the manufacturing equipment and testers 340 and test data from the system-level tester 360. During a second phase, the neural network circuit 370 may be used to make pass/fail determinations.

In operation, the ingot (not shown) may be divided into the training wafers 320 and the production waters 322. In a specific, non-limiting example, the training wafers 320 may include a first wafer at a first end; a second wafer 25% of the way through the ingot longitudinally; a third wafer 50% of the way through the ingot, longitudinally; a fourth wafer 75% of the way through the ingot, longitudinally, and a fifth wafer at a second end of the ingot. The production wafers 322 may include remaining waters from the ingot. During a first phase (e.g., training phase), the training wafers 320 may be put through the manufacturing equipment and testers 340 and the resultant semiconductor dice 350 may fully tested via system-level tester 360 to determine whether each individual end-product passes or fails a system-level verification test. Test data from the manufacturing equipment and testers 340 and the system-level tester 360 may be used to train the neural network circuit 370. During a second phase (e.g., test phase), the production wafers 322 may be may be put through the manufacturing equipment and testers 340 to provide the resultant semiconductor dice 350 and resultant test data. The resultant test data for each of the end products 350 may be provided to the prediction circuit 270, and the neural network circuit 370 may use the resultant test data to determine whether each individual end-product of the semiconductor dice 350 passes or fails a system-level verification test. Determining pass/fail information using the neural network circuit 370, rather than performing the system-level verification test may reduce manufacturing costs and time.

During fabrication and assembly, each of the training wafers 320 and production wafers 322 may undergo assembly-level tests via the testers 344(1-4) as they are transformed into the respective semiconductor dice 350. During the first phase, the system-level tester 360 may perform system-level verification testing on each of the semiconductor dice 350 from the training wafers 320 to determine pass or fail information. The test data from the testers 344(1-4) and from the system-level tester 360 for the each of the semiconductor dice 350 produced from the training wafers 320 may be provided to the neural network circuit 370. The neural network circuit 370 may use the test data from each of the manufacturing equipment and testers 340 and the system-level tester 360 to train neural network circuit 370 to predict whether a given semiconductor die 350 is likely to pass or fail system-level verification testing.

The manufacturing equipment and testers 340 may fabricate, assemble, and test the semiconductor dice 350. The fabrication and assembly may include multiple steps performed by the manufacturing equipment. The manufacturing equipment communicate with the testers 344(1-4). The testers 344(1-4) may perform assembly-level tests to measure characteristics of the training wafers 320 at certain points in the assembly process in transforming the training wafers 320 and the production wafers 322 into the semiconductor dice 350. For example, the 344(1) may include a wafer-level test to measure water health along scribe lines of the wafer using special purpose inter-die variation (IDV) circuits, the 344(2) may perform a die-level test after fabrication, but before packaging to determine the health of each individual die, the 344(3) may perform a die-level built-in test using on-die logic to determine health of the individual die, and the 344(4) may perform class tests on the dice after packaging to determine health of an individual die.

The manufacturing equipment and the testers 344(1-4) may include transceivers to communicate the test data to the neural network circuit 370. The test data may include various electrical parameters derived from the tests, such as leakage current, transistor drive strengths, device capacitances, transistor performance (e.g., measured by ring oscillator test structure frequencies), metal resistance, interconnect capacitance, optical images of various layers of the semiconductor die 150, etc. Further, specialized circuits may be included in each of the semiconductor dice 350 to collect performance, power, and functionality-related data from each of the semiconductor dice 350. In some examples, electrical parametric data like leakage current, transistor drive strengths, and transistor threshold voltages may tend to correlate with system level performance metrics like clock frequency and long term reliability (as measured by mean time to fail), respectively, Based on prior knowledge of parameters that tend to correlate with system level performance metrics (e.g., system level pass/fail), one of skill in the art may preselect such input parameters to be included in the test data for the neural network training to quantify the dependence of these preselected input parameters to the output to be predicted. In some embodiments, preselection of particular parameters may be unnecessary (e.g., all test data parameters may be provided, instead), as the training of the neural network may provide for computation of individual input parameter weights, and thereby quantify the dependence of each of the individual input parameters to the output to be predicted (e.g., system level pass/fail.) In some examples, the manufacturing equipment and testers 340 may further communicate other telemetry data, such as environmental data or equipment health data, to the neural network circuit 370. During the first phase, the neural network circuit 370 may use the test data, telemetry data, or combinations thereof, to train the network. The manufacturing equipment and testers 344(1-4) of the manufacturing equipment and testers 340 may further communicate telemetry with each other or with a central computer or server during the assembly process. The communication of the telemetry data may be used to effect changes to the manufacturing equipment 342(1-N) or the testers 344(1-4) during assembly, such as a central computer or server changing one or more settings in the manufacturing equipment 342(1-N), the testers 344(1-4), the system-level tester 360, the neural network circuit 370, or combinations thereof In some examples, the neural network circuit 370 may be included in the central computer or server.

During the first phase, the system-level tester 360 may perform the system-level verification tests on the on the semiconductor dice 350 produced from the training wafers 320 to make a pass/fail determination. The pass/fail information from the system-level tester 360 may be provided to the neural network circuit 370. The neural network circuit 370 may use the test and/or other telemetry data from the testers 344(1-4), along with the test data from the system-level tester 360, to train the predictive model. The training may include the neural network circuit 370 identifying correlations between the test and/or other telemetry data from the manufacturing equipment and testers 340 that result in pass indication from the system-level tester 360, and may identify correlations between test and other data from the manufacturing equipment and testers 340 that result in a fail indication from the system-level tester 360. In some embodiments, the predictive model of the neural network circuit 370 may include a neural network, such as a two-layer perceptron neural network.

Once the neural network circuit 370 is trained, the system 300 may enter a second phase in which the neural network circuit 370 makes system-level pass/fail determinations for individual ones of the semiconductor dice 350 produced from the production wafers 322 based on test and other data from the testers 344(1-4). The neural network circuit 370 may be implemented determine pass or fail of individual ones of the semiconductor dice 350 in lieu of performing comprehensive system-level verification tests via the system-level tester 360. In some examples, the neural network circuit 370 may directly provide the pass or fail for each. In other examples, when the confidence of a predicted pass or fail by the neural network circuit 370 falls outside a threshold for a particular semiconductor dice 350, the neural network circuit 370 may indicate performance of a system-level verification test is necessary by the system-level tester 360. Further, the predictive model of the neural network circuit 370 may be updated randomly (e.g., random selection of an additional pilot unit to undergo system-level verification testing), periodically (e.g., periodic selection of an additional pilot unit to undergo system-level verification testing), or as conditions within or around the manufacturing equipment and testers 340 change, Further, the neural network circuit 370 may be trained using another method, such as using historical test and pass/fail data.

In some examples, the system-level tester 360 may perform a system-level verification test on select pilot dice of the semiconductor dice 350 produced from each of the production wafers 322, and may provide the test data from manufacturing equipment and testers 340 and the system-level tester 360 to further train the neural network circuit 370. The pilot dice may be selected at the same relative locations on each of the production wafers 322. For example, the exemplary wafer 390 identifies exemplary pilot dice locations 396 that may be used for each individual wafer of the production wafers 322. It would be appreciated that other locations and more or fewer pilot dice may be used. The 390 also identifies exemplary predicted pass and fail from the neural network circuit 370 for each dice produced from the 390. Selection of the pilot die as described above may improve inter-die and inter-wafer correlation training of the neural network circuit 370, which may improve an ability of the neural network circuit 370 to accurately predict pass/fail of system-level verification tests.

In some examples, the neural network circuit 370 may be stored as instructions at machine readable media of a computer or server that are executable by one or more processor units to train using data from the manufacturing equipment and testers 340 and the system-level tester 360 and to provide pass/fail predictions for the semiconductor dice 350 using data from the manufacturing equipment and testers 340. In another example, the neural network circuit 370 may be included in the system-level tester 360. Using the predictive model of the neural network circuit 370 in lieu of performing system-level tests via the system-level tester 360 for the semiconductor dice 350 may reduce production time and reduce production costs.

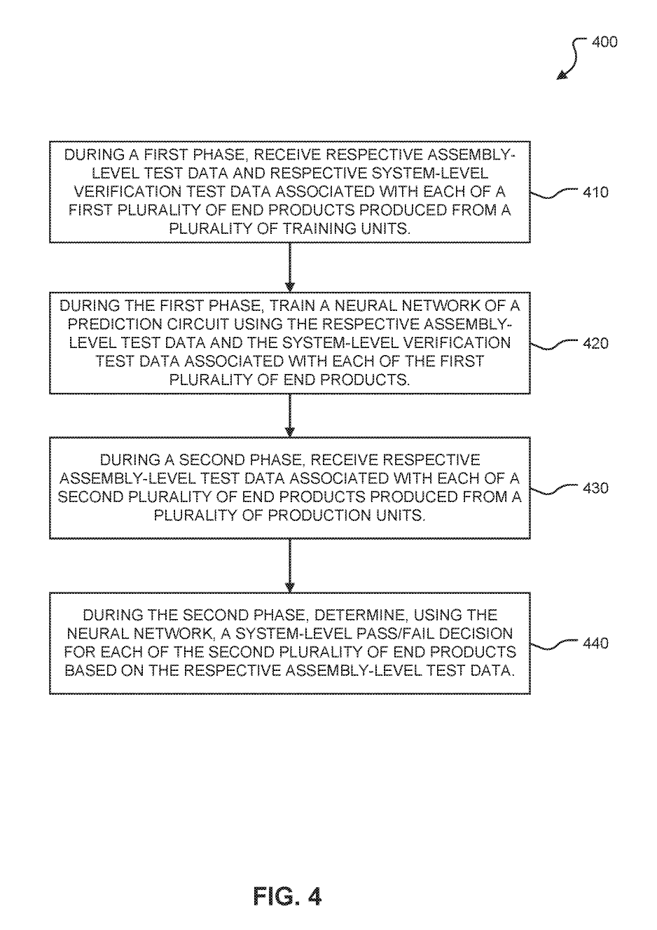

FIG. 4 illustrates a method 400 to generate system-level verification predictions in accordance with some embodiments. The method 400 may be implemented in the prediction circuit 270 of FIG. 1, the prediction circuit 270 of FIG. 2, the neural network circuit 370 of FIG. 3, or combinations thereof.

The method 400 may include, during a first phase, receiving respective assembly-level test data and respective system-level verification test data associated with each of a first plurality of end products, at 410. The first plurality of end products produced from a plurality of training units. The first plurality of end products may be any of the end products 150 of FIG. 1, the end products 250 of FIG. 2, the semiconductor dice 350 of FIG. 3, or combinations thereof. The plurality of training units may include the training units 120 of FIG. 1, the training units 220 of FIG. 2, the training wafers 320 of FIG. 3, or combinations thereof The assembly-level test data may be received from any of the testers of the manufacturing equipment and testers 140 of FIG. 1. the testers 244(1-N), the testers 344(1-4) of FIG. 3, or combinations thereof. The system-level test data may be received from any of the system-level tester 160 of FIG. 1, the system-level tester 260 of FIG. 2, the system-level tester 360 of FIG. 3, or combinations thereof.

The method 400 may further include receiving telemetry data from a tester. The tester may include the testers of the manufacturing equipment and testers 140 or the system-level tester 160 of FIG. 1, the testers 244(1-N) or the system-level tester 260 of FIG. 2, the testers 344(1-4) or the system-level tester 360 of FIG. 3, or combinations thereof.

The method 400 may include, during the first phase, training a neural network of a prediction circuit using the respective assembly-level test data and the system-level verification test data associated with each of the first plurality of end products, at 420. The method 400 may further include training the neural network further using the telemetry data. The telemetry data may include environmental data or tester health data.

The method 400 may include, during a second phase, receiving respective assembly-level test data associated with each of a second plurality of end products, at 430. The second plurality of end products produced from a plurality of production units. The second plurality of end products may be any of the end products 150 of FIG. 1, the end products 250 of FIG. 2, the semiconductor dice 350 of FIG. 3, or combinations thereof The plurality of production units may include the production units 122 of FIG. 1, the production units 222 of FIG. 2, the production wafers 322 of FIG. 3, or combinations thereof The plurality of training units and the plurality of production units may be divided from a common supply, such as the supply 110 of FIG. 1.

The method 400 may further include communicating with a plurality of testers to receive the respective assembly-level test data associated with each of the first plurality of end products and the respective assembly-level test data associated with each of the second plurality of end products. The plurality of testers may include the testers of the manufacturing equipment and testers 140 of FIG. 1, the testers 244(1-N) of FIG. 2, the testers 344(1-4) of FIG. 3, or combinations thereof.

The method 400 may include, during the second phase, determining, using the neural network, a system-level pass/fail decision for each of the second plurality of end products based on the respective assembly-level test data, at 440,

The method 400 may further include receiving respective assembly-level test data and respective system-level verification test data associated with each of a third plurality of end products produced from the plurality of production units and training the neural network using the respective assembly-level test data and the system-level verification test data associated with each of the third plurality of end products. The third plurality of end products may be any of the end products 150 of FIG. 1, the end products 250 of FIG. 2, the semiconductor dice 350 of FIG. 3, or combinations thereof.

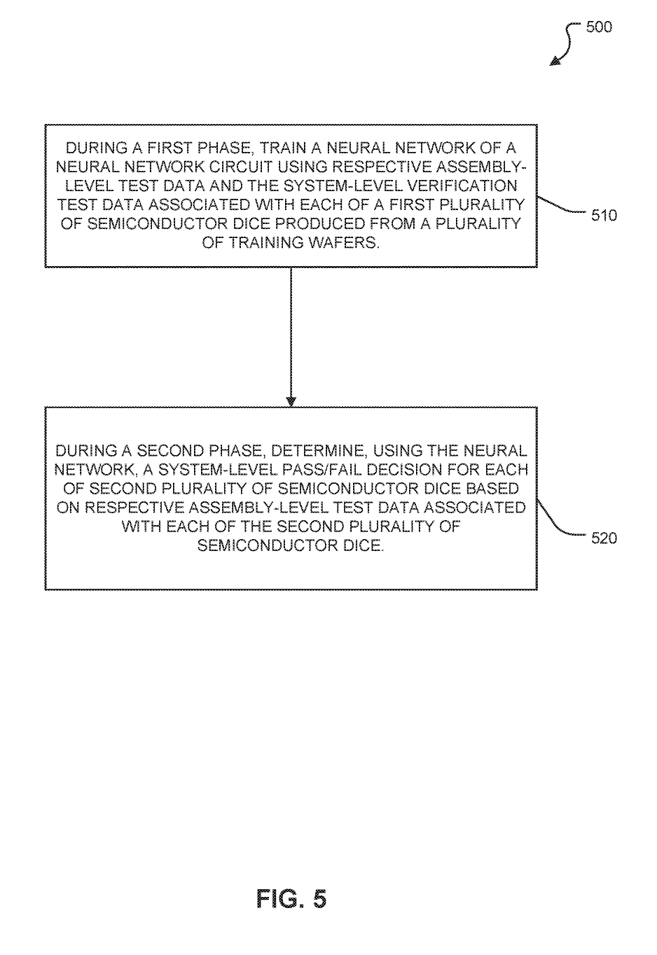

FIG. 5 illustrates a method 500 to generate system-level verification predictions in accordance with some embodiments. The method 500 may be implemented in the prediction circuit 270 of FIG. 1, the prediction circuit 270 of FIG. 2, the neural network circuit 370 of FIG. 3. or combinations thereof.

The method 500 may include, during a first phase, training a neural network of a neural network circuit using respective assembly-level test data and the system-level verification test data associated with each of a first plurality of semiconductor dice produced from a plurality of training wafers, at 510. The first plurality of semiconductor dice may be any of the end products 150 of FIG. 1, the end products 250 of FIG. 2, the semiconductor dice 350 of FIG. 3, or combinations thereof. The plurality of training wafers may include the training units 120 of FIG. 1, the training units 220 of FIG. 2, the training wafers 320 of FIG. 3, or combinations thereof The assembly-level test data may be received from any of the testers of the manufacturing equipment and testers 140 of FIG. 1, the testers 244(1-N), the testers 344(1-4) of FIG. 3, or combinations thereof. In some embodiments, assembly-level test data associated with each of a first plurality of semiconductor dice includes wafer-level test data and semiconductor-die level test data. The assembly-level test data may include leakage current, transistor drive strengths, device capacitances, transistor performance, metal resistance, interconnect capacitance, optical images, or combinations thereof. The system-level test data may be received from any of the system-level tester 160 of FIG. 1, the system-level tester 260 of FIG. 2, the system-level tester 360 of FIG. 3, or combinations thereof.

The method 500 may include, during a second phase, determining, using the neural network, a system-level pass/fail decision for each of second plurality of semiconductor dice based on respective assembly-level test data associated with each of the second plurality of semiconductor dice, the second plurality of semiconductor dice produced from a plurality of production wafers, at 520. The second plurality of semiconductor dice may be any of the end products 150 of FIG. 1, the end products 250 of FIG. 2, the semiconductor dice 350 of FIG. 3, or combinations thereof. The plurality of production wafers may include the production units 122 of FIG. 1, the production units 222 of FIG. 2, the production wafers 322 of FIG. 3, or combinations thereof

The method 500 may further include, during the second phase, training the neural network using the respective assembly-level test data and the system-level verification test data associated with each of a third plurality of semiconductor dice produced from each of the plurality of production wafers. The third plurality of semiconductor dice may be any of the end products 150 of FIG. 1, the end products 250 of FIG. 2, the semiconductor dice 350 of FIG. 3, or combinations thereof. In some embodiments, the third plurality of semiconductor dice are produced from specified locations on each of the plurality of production wafers. In some embodiments, the third plurality of semiconductor dice are produced from common specified locations on each of the plurality of production waters. In some embodiments, training the neural network using the respective assembly-level test data and the system-level verification test data associated with each of the third plurality of semiconductor dice may include determining inter-wafer correlation.

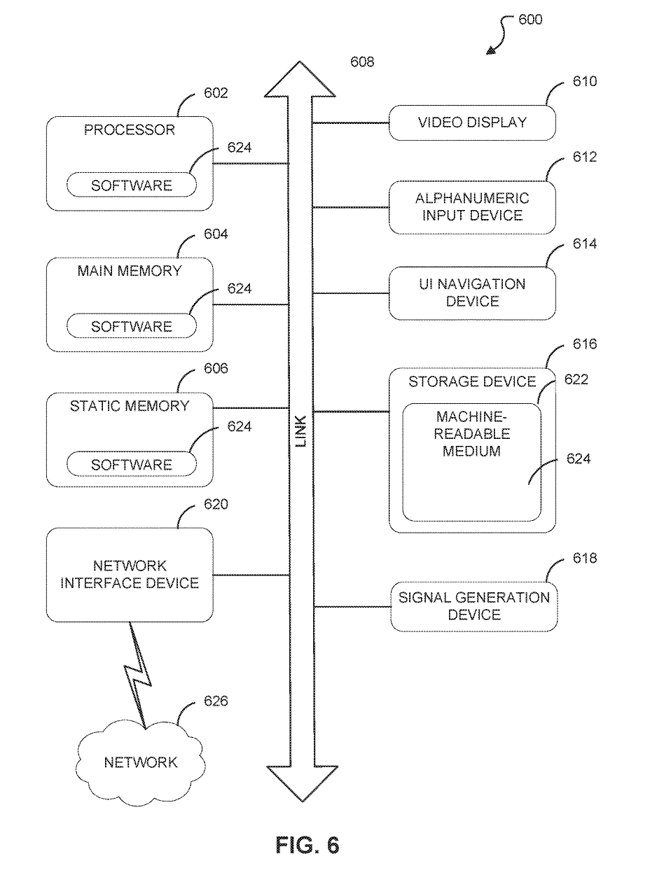

FIG. 6 is a block diagram illustrating a machine in the example form of a computer system 600, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a personal computer (PC), a tablet PC, a hybrid tablet, a server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor unit 602 (e.g., a central processing unit (CPU), a graphics processing unit (GPU) or both, processor cores, compute nodes, etc.), a main memory 604 and a static memory 606, which communicate with each other via a link 608 (e.g., bus). The computer system 600 may further include a video display unit 610, an alphanumeric input device 612 (e.g., a keyboard), and a user interface (UI) navigation device 614 (e.g., a mouse). In one embodiment, the video display unit 610, input device 612 and UI navigation device 614 are incorporated into a touch screen display. The computer system 600 may additionally include a storage device 616 (e.g., a drive unit), a signal generation device 618 (e.g., a speaker), a network interface device 620, and one or more sensors (not show), such as a global positioning system (GPS) sensor, compass, accelerometer, gyrometer, magnetometer, or other sensor.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor unit 602 during execution thereof by the computer system 600, with the main memory 604, static memory 606, and the processor unit 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices, magnetic disks such as internal hard disks and removable disks magneto-optical disks; and CD-ROM and DVD-ROM disks.

The instructions 624 may further be transmitted or received over a communications network 626 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, 3G, and 4G LTE/LTE-A or WiiMAX networks). The term “transmission medium” shall be taken to include any intangible medium that is capable of storing, encoding, or carrying instructions for execution by the machine, and includes digital or analog communications signals or other intangible medium to facilitate communication of such software.

Various illustrative components, blocks, configurations, modules, and steps have been described above generally in terms of their functionality. Skilled artisans may implement the described functionality in varying ways for each particular application, but such implementation decisions should not be interpreted as causing a departure from the scope of the present disclosure.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as previously described.

Examples, as described herein, may include, or may operate on, logic or a number of components, modules, or mechanisms. Modules are tangible entities (e.g., hardware) capable of performing specified operations and may be configured or arranged in a certain manner, in an example, circuits may be arranged (e.g., internally or with respect to external entities such as other circuits) in a specified manner as a module. In an example, the software may reside on at least one machine-readable medium.

The term “module” is understood to encompass a tangible entity, be that an entity that is physically constructed, specifically configured (e.g., hardwired), or temporarily (e.g., transitorily) configured (e.g., programmed) to operate in a specified manner or to perform at least part of any operation described herein. Considering examples in which modules are temporarily configured, a module need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. The terms “application, process, or service,” or variants thereof, is used expansively herein to include routines, program modules, programs, components, and the like, and may be implemented on various system configurations, including single-processor or multiprocessor systems, microprocessor-based electronics, single-core or multi-core systems, combinations thereof, and the like. Thus, the terms “application, process, or service” may be used to refer to an embodiment of software or to hardware arranged to perform at least part of any operation described herein.

While a machine-readable medium may include a single medium, the term “machine-readable medium” may include a single medium or multiple media (e.g., a centralized or distributed database, and/or associated caches and servers)

### Additional Notes & Examples

Example 1 is a device to generate system-level verification predictions comprising: a prediction circuit including a neural network, the prediction circuit to: during a first phase: receive respective assembly-level test data and respective system-level verification test data associated with each of a first plurality of end products, the first plurality of end products produced from a plurality of training units; and train the neural network using the respective assembly-level test data and the system-level verification test data associated with each of the first plurality of end products; and during a second phase: receive respective assembly-level test data associated with each of a second plurality of end products, the second plurality of end products produced from a plurality of production units; and determine, using the neural network, a system-level pass/fail decision for each of the second plurality of end products based on the respective assembly-level test data.

In Example 2, the subject matter of Example 1 optionally includes a transceiver to receive the respective assembly-level test data associated with each of the first plurality of end products and the respective assembly-level test data associated with each of the second plurality of end products.

In Example 3, the subject matter of Example 2. optionally includes wherein the transceiver communicates with a plurality of testers to receive the respective assembly-level test data associated with each of the first plurality of end products and the respective assembly-level test data associated with each of the second plurality of end products.

In Example 4, the subject matter of any one or more of Examples 2-3 optionally include wherein the transceiver further to receive the respective system-level test data associated with each of the first plurality of end products.

In Example 5, the subject matter of any one or more of Examples 1-4 optionally include wherein the prediction circuit further to receive telemetry data from a tester, wherein training of the neural network further uses the telemetry data.

In Example 6, the subject matter of Example 5 optionally includes wherein the telemetry data includes environmental data or tester health data.

In Example 7, the subject matter of any one or more of Examples 1-6 optionally include wherein, during the second phase, the prediction circuit further to: receive respective assembly-level test data and respective system-level verification test data associated with each of a third plurality of end products, the third plurality of end products produced from the plurality of production units; and train the neural network using the respective assembly-level test data and the system-level verification test data associated with each of the third plurality of end products.

In Example 8, the subject matter of any one or more of Examples 1-7 optionally include wherein the plurality of training units and the plurality of production units are divided from a common supply.

In Example 9, the subject matter of any one or more of Examples 1-8 optionally include wherein the plurality of production units includes semiconductor wafers and the second plurality of end products includes semiconductor dice.

Example 10 is a device to generate system-level verification predictions comprising: a neural network circuit including a neural network, wherein, during a first phase, the neural network circuit to train the neural network using respective assembly-level test data and the system-level verification test data associated with each of a first plurality of semiconductor dice, the first plurality of semiconductor dice produced from a plurality of training wafers, wherein, during a second phase, the neural network circuit to determine, using the neural network, a system-level pass/tail decision for each of second plurality of semiconductor dice based on respective assembly-level test data associated with each of the second plurality of semiconductor dice, the second plurality of semiconductor dice produced from a. plurality of production wafers.

In Example 11, the subject matter of Example 10 optionally includes wherein, during the second phase, the neural network circuit further to train the neural network using the respective assembly-level test data and the system-level verification test data associated with each of a third plurality of semiconductor dice, the third plurality of semiconductor dice produced from each of the plurality of production wafers.

In Example 12, the subject matter of Example 11 optionally includes wherein the third plurality of semiconductor dice are produced from specified locations on each of the plurality of production wafers.

In Example 13, the subject matter of any one or more of Examples 11-12 optionally include wherein the third plurality of semiconductor dice are produced from common specified locations on each of the plurality of production wafers.

In Example 14, the subject matter of Example 13 optionally includes wherein to train the neural network using the respective assembly-level test data and the system-level verification test data associated with each of the third plurality of semiconductor dice includes the neural network to determine inter-wafer correlation.

In Example 15, the subject matter of any one or more of Examples 10-14 optionally include wherein the plurality of training wafers and the plurality of production wafers are sliced from a common ingot of semiconductor material.

In Example 16, the subject matter of any one or more of Examples 10-15 optionally include wherein assembly-level test data associated with each of a first plurality of semiconductor dice includes wafer-level test data and semiconductor-die level test data.

In Example 17, the subject matter of any one or more of Examples 10-16 optionally include wherein assembly-level test data includes leakage current, transistor drive strengths, device capacitances, transistor performance, metal resistance, interconnect capacitance, optical images, or combinations thereof

Example 18 is a method to generate system-level verification predictions comprising: during a first phase: receiving respective assembly-level test data and respective system-level verification test data associated with each of a first plurality of end products, the first plurality of end products produced from a plurality of training units; and training a neural network of a prediction circuit using the respective assembly-level test data and the system-level verification test data associated with each of the first plurality of end products; and during a second phase: receiving respective assembly-level test data associated with each of a second plurality of end products, the second plurality of end products produced from a plurality of production units; and determining, using the neural network, a system-level pass/fail decision for each of the second plurality of end products based on the respective assembly-level test data.

In Example 19, the subject matter of Example 18 optionally includes communicating with a plurality of testers to receive the respective assembly-level test data associated with each of the first plurality of end products and the respective assembly-level test data associated with each of the second plurality of end products.

In Example 20, the subject matter of any one or more of Examples 18-19 optionally include receiving telemetry data from a tester, wherein training of the neural network further uses the telemetry data.

In Example 21, the subject matter of Example 20 optionally includes wherein the telemetry data includes environmental data or tester health data.

In Example 22, the subject matter of any one or more of Examples 18-21 optionally include receiving respective assembly-level test data and respective system-level verification test data associated with each of a third plurality of end products produced from the plurality of production units; and training the neural network using the respective assembly-level test data and the system-level verification test data associated with each of the third plurality of end products.

In Example 23, the subject matter of any one or more of Examples 18-22 optionally include wherein the plurality of training units and the plurality of production units are divided from a common supply.

In Example 24, the subject matter of any one or more of Examples 18-23 optionally include wherein the plurality of production units includes semiconductor wafers and the second plurality of end products includes semiconductor dice.

Example 25 is at least one medium including instructions that, when executed on a machine cause the machine to perform any of the methods of Examples 18-24.

Example 26 is an apparatus comprising means for performing any of the methods of Examples 18-24.

Example 27 is a method to generate system-level verification predictions comprising: during a first phase, training a neural network of a neural network circuit using respective assembly-level test data and the system-level verification test data associated with each of a first plurality of semiconductor dice produced from a plurality of training wafers; and during a second phase, determining, using the neural network, a system-level pass/fail decision for each of second plurality of semiconductor dice based on respective assembly-level test data associated with each of the second plurality of semiconductor dice, the second plurality of semiconductor dice produced from a plurality of production wafers.

In Example 28, the subject matter of Example 27 optionally includes wherein, during the second phase, training the neural network using the respective assembly-level test data and the system-level verification test data associated with each of a third plurality of semiconductor dice produced from each of the plurality of production wafers.

In Example 29, the subject matter of Example 28 optionally includes wherein the third plurality of semiconductor dice are produced from specified locations on each of the plurality of production wafers.

In Example 30, the subject matter of any one or more of Examples 28-29 optionally include wherein the third plurality of semiconductor dice are produced from common specified locations on each of the plurality of production wafers

In Example 31, the subject matter of Example 30 optionally includes wherein training the neural network using the respective assembly-level test data and the system-level verification test data associated with each of the third plurality of semiconductor dice includes determining inter-wafer correlation.

In Example 32, the subject matter of any one or more of Examples 27-31 optionally include wherein assembly-level test data associated with each of a first plurality of semiconductor dice includes wafer-level test data and semiconductor-die level test data.

In Example 33, the subject matter of any one or more of Examples 27-32 optionally include wherein the assembly-level test data includes leakage current, transistor drive strengths, device capacitances, transistor performance, metal resistance, interconnect capacitance, optical images, or combinations thereof.

Example 34 is at least one medium including instructions that, when executed on a machine cause the machine to perform any of the methods of Examples 27-33.

Example 35 is an apparatus comprising means for performing any of the methods of Examples 27-33.

Example 36 is an apparatus comprising: during a first phase: means for receiving respective assembly-level test data and respective system-level verification test data associated with each of a first plurality of end products, the first plurality of end products produced from a plurality of training units; and means for training a neural network of a prediction circuit using the respective assembly-level test data and the system-level verification test data associated with each of the first plurality of end products; and during a second phase: means for receiving respective assembly-level test data associated with each of a second plurality of end products, the second plurality of end products produced from a plurality of production units; and means for determining, using the neural network, a system-level pass/fail decision for each of the second plurality of end products based on the respective assembly-level test data.

In Example 37, the subject matter of Example 36 optionally includes means for communicating with a plurality of testers to receive the respective assembly-level test data associated with each of the first plurality of end products and the respective assembly-level test data associated with each of the second plurality of end products.

In Example 38, the subject matter of Example 37 optionally includes means for receiving telemetry data from a tester, wherein training of the neural network further uses the telemetry data.

In Example 39, the subject matter of Example 38 optionally includes Wherein the telemetry data includes environmental data or tester health data.

In Example 40, the subject matter of any one or more of Examples 36-39 optionally include means for receiving respective assembly-level test data and respective system-level verification test data associated with each of a third plurality of end products produced from the plurality of production units; and means for training the neural network using the respective assembly-level test data and the system-level verification test data associated with each of the third plurality of end products.

In Example 41, the subject matter of any one or more of Examples 36-40 optionally include wherein the plurality of training units and the plurality of production units are divided from a common supply.

In Example 42, the subject matter of any one or more of Examples 36-41 optionally include wherein the plurality of production units includes semiconductor wafers and the second plurality of end products includes semiconductor dice.

Example 43 is an apparatus comprising: during a first phase, means for training a neural network of a neural network circuit using respective assembly-level test data and the system-level verification test data associated with each of a first plurality of semiconductor dice produced from a plurality of training wafers; and during a second phase, means for determining, using the neural network, a system-level pass/fail decision for each of second plurality of semiconductor dice based on respective assembly-level test data associated with each of the second plurality of semiconductor dice, the second plurality of semiconductor dice produced from a plurality of production wafers.

in Example 44, the subject matter of Example 43 optionally includes wherein, during the second phase, means for training the neural network using the respective assembly-level test data and the system-level verification test data associated with each of a third plurality of semiconductor dice produced from each of the plurality of production wafers.

In Example 45, the subject matter of Example 44 optionally includes wherein the third plurality of semiconductor dice are produced from specified locations on each of the plurality of production wafers.

In Example 46, the subject matter of any one or more of Examples 44-45 optionally include wherein the third plurality of semiconductor dice are produced from common specified locations on each of the plurality of production wafers.

In Example 47, the subject matter of Example 46 optionally includes wherein means for training the neural network using the respective assembly-level test data and the system-level verification test data associated with each of the third plurality of semiconductor dice includes means for determining inter-wafer correlation.

In Example 48, the subject matter of any one or more of Examples 43-47 optionally include wherein assembly-level test data associated with each of a first plurality of semiconductor dice includes wafer-level test data and semiconductor-die level test data.

In Example 49, the subject matter of any one or more of Examples 43-48 optionally include wherein assembly-level test data includes leakage current, transistor drive strengths, device capacitances, transistor performance, metal resistance, interconnect capacitance, optical images, or combinations thereof.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description, The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. However, the claims may not set forth features disclosed herein because embodiments may include a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A device to perform system-level verification predictions comprising:
a prediction circuit including a neural network, the prediction circuit to:
during a first phase:
receive respective assembly-level test data and respective system-level verification test data associated with each of a first plurality of end products, the first plurality of end products produced from a plurality of training units; and
train the neural network using the respective assembly-level test data and the system-level verification test data associated with each of the first plurality of end products; and
during a second phase:
receive respective assembly-level test data associated with each of a second plurality of end products, the second plurality of end products produced from a plurality of production units; and
determine, using the neural network, a system-level pass/fail decision for each of the second plurality of end products based on the respective assembly-level test data.

2. The device of claim 1, further comprising a transceiver to receive the respective assembly-level test data associated with each of the first plurality of end products and the respective assembly-level test data associated with each of the second plurality of end products.

3. The device of claim 2, wherein the transceiver communicates with a plurality of testers to receive the respective assembly-level test data associated with each of the first plurality of end products and the respective assembly-level test data associated with each of the second plurality of end products.

4. The device of claim 2, wherein the transceiver further to receive the respective system-level test data associated with each of the first plurality of end products.

5. The device of claim 1, wherein the prediction circuit further to receive telemetry data from a tester, wherein training of the neural network further uses the telemetry data.

6. The device of claim 5, wherein the telemetry data includes environmental data or tester health data.

7. The device of claim 1, wherein, during the second phase, the prediction circuit further to:
receive respective assembly-level test data and respective system-level verification test data associated with each of a third plurality of end products, the third plurality of end products produced from the plurality of production units; and
further train the neural network using the respective assembly-level test data and the system-level verification test data associated with each of the third plurality of end products.

8. The device of claim 1, wherein the plurality of training units and the plurality of production units are divided from a common supply.

9. The device of claim 1, wherein the plurality of production units includes semiconductor wafers and the second plurality of end products includes semiconductor dice.

10. A device to perform system-level verification predictions comprising:
a neural network circuit including a neural network, wherein, during a first phase, the neural network circuit to train the neural network using respective assembly-level test data and the system-level verification test data associated with each of a first plurality of semiconductor dice, the first plurality of semiconductor dice produced from a plurality of training wafers, wherein, during a second phase, the neural network circuit to determine, using the neural network, a system-level pass/fail decision for each of second plurality of semiconductor dice based on respective assembly-level test data associated with each of the second plurality of semiconductor dice, the second plurality of semiconductor dice produced from a plurality of production wafers.

11. The device of claim 10, wherein, during the second phase, the neural network circuit further to train the neural network using the respective assembly-level test data and the system-level verification test data associated with each of a third plurality of semiconductor dice, the third plurality of semiconductor dice produced from each of the plurality of production wafers.

12. The device of claim 11, wherein the third plurality of semiconductor dice are produced from specified locations on each of the plurality of production wafers

13. The device of claim 10, wherein the plurality of training wafers and the plurality of production wafers are sliced from a common ingot of semiconductor material.

14. The device of claim 10, wherein assembly-level test data associated with each of a first plurality of semiconductor dice includes wafer-level test data and semiconductor-die level test data.

15. The device of claim 10, wherein assembly-level test data includes leakage current, transistor drive strengths, device capacitances, transistor performance, metal resistance, interconnect capacitance, optical images, or combinations thereof.

16. At least one machine-readable medium including instructions that, when executed on a machine cause the machine to perform operations including:
during a first phase:
receive respective assembly-level test data and respective system-level verification test data associated with each of a first plurality of end products, the first plurality of end products produced from a plurality of training units; and
train a neural network of a prediction circuit using the respective assembly-level test data and the system-level verification test data associated with each of the first plurality of end products; and
during a second phase:
receive respective assembly-level test data associated with each of a second plurality of end products, the second plurality of end products produced from a plurality of production units; and
determine, using the neural network, a system-level pass/fail decision for each of the second plurality of end products based on the respective assembly-level test data.

17. The machine-readable medium of claim 16, including instructions that, when executed on the machine, cause the machine to perform operations including communicating with a plurality of testers to receive the respective assembly-level test data associated with each of the first plurality of end products and the respective assembly-level test data associated with each of the second plurality of end products.

18. The machine-readable medium of claim 17, including instructions that, when executed on the machine, cause the machine to perform operations including receiving telemetry data from a tester, wherein training of the neural network further uses the telemetry data.

19. The machine-readable medium of claim 18 wherein the telemetry data includes environmental data or tester health data.

20. The machine-readable medium of claim 16, including instructions that, when executed on the machine, cause the machine to perform operations including:
receiving respective assembly-level test data and respective system-level verification test data associated with each of a third plurality of end products produced from the plurality of production units; and
training the neural network using the respective assembly-level test data and the system-level verification test data associated with each of the third plurality of end products.

21. A method to perform system-level verification predictions comprising:
during a first phase, training a neural network of a neural network circuit using respective assembly-level test data and the system-level verification test data associated with each of a first plurality of semiconductor dice produced from a plurality of training wafers; and
during a second phase, determining, using the neural network, a system-level pass/fail decision for each of second plurality of semiconductor dice based on respective assembly-level test data associated with each of the second plurality of semiconductor dice, the second plurality of semiconductor dice produced from a plurality of production wafers. The method of claim 21, wherein, during the second phase, training the neural network using the respective assembly-level test data and the system-level verification test data associated with each of a third plurality of semiconductor dice produced from each of the plurality of production wafers.

23. The method of claim 22, wherein the third plurality of semiconductor dice are produced from common specified locations on each of the plurality of production wafers.

24. The method of claim 23, wherein training the neural network using the respective assembly-level test data and the system-level verification test data associated with each of the third plurality of semiconductor dice includes determining inter-wafer correlation.

25. The method of claim 21, wherein the assembly-level test data associated with each of a first plurality of semiconductor dice includes wafer-level test data and semiconductor-die level test data.
